(19) United States
(12) Patent Application Publication
(10) Pub. No.: US 2016/0305791 A1
(43) Pub. Date: Oct. 20, 2016

(54) VEHICLE ENERGY ALERT SYSTEMS AND METHODS

(71) Applicant: FORD GLOBAL TECHNOLOGIES, LLC, Dearborn, MI (US)

(72) Inventors: Cynthia M. NEUBECKER, Westland, MI (US); Scott Alan WATKINS, Canton, MI (US); John Robert VAN WIEMEERSCH, Novi, MI (US)

(21) Appl. No.: 14/686,168

(22) Filed: Apr. 14, 2015

(51) Int. Cl. G01C 21/34; B60L 11/18; B60R 16/023

(52) U.S. Cl. CPC G01C 21/3469; B60R 16/0232; B60R 16/0237; B60L 11/1861

(57) ABSTRACT

A vehicle alert system may include a controller configured to receive a waypoint and a current vehicle energy, determine a route to the waypoint and vehicle energy necessary to accomplish the route, receive waypoint information indicative of non-driving energy consumption associated with the waypoint, and generate an adjustment factor based on the non-driving energy consumption. The controller may further be configured to attribute the adjustment factor to the vehicle energy necessary to accomplish the route, determine whether the attributed vehicle energy exceeds the current vehicle energy, and issue an alert in response to the attributed vehicle energy exceeding the current vehicle energy.

### TECHNICAL FIELD

Disclosed herein are vehicle energy alert systems and methods.

### BACKGROUND

The availability and inclusion of navigational systems in vehicles has created a variety of opportunities with respect to driver navigation. Drivers may be provided with a fastest route, a non-highway route, a fuel-efficient route, etc. In some cases, especially with respect to electric vehicles, navigation systems may predict whether or not the vehicle has enough energy (e.g., enough battery charge or fuel supply) to reach a desired destination.

### SUMMARY

A vehicle alert system may include a controller configured to receive waypoint information indicative of non-driving energy consumption associated with a waypoint, to modify an estimate of vehicle energy necessary to travel to the waypoint based on the non-driving energy consumption to generate a modified estimate, and to issue an alert in response to the modified estimate exceeding a current vehicle energy.

A vehicle alert method may, by a controller, receive a waypoint and a current energy level, classify the waypoint based on waypoint attributes indicative of potential non-driving energy consumption at the waypoint, generate an adjustment factor based on the potential non-driving energy consumption, modify the current energy level by the adjustment factor, and issue an alert in response to the modified energy level exceeding the current energy level.

A vehicle may include an interface; and a controller configured to, in response to an indication of expected non-driving energy consumption at a destination for the vehicle, issue an alert via the interface provided an estimate of vehicle energy necessary to travel to the drive cycle destination that is based on the expected non-driving energy consumption exceeds a current vehicle energy.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIGS. 1A and 1B illustrate an example diagram of a system that may be used to provide telematics services to a vehicle;

FIG. 2A illustrates an example diagram of a vehicle route;

FIG. 2B illustrates an example diagram of another vehicle route;

FIG. 3 illustrates an example process for a vehicle energy alert system; and

FIG. 4 illustrates another example process for a vehicle energy alert system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Described herein is a vehicle energy alert system configured to warn a driver when a vehicle's energy may be affected by non-driving activity such as opening of doors, use of vehicle systems such as lights, self-discharge of batteries, or use of fuel for fuel fired heaters, remote start events, etc. These non-driving activities may be attributable to a type of destination such as a campground, tailgate area, etc., where the vehicle may be used while it is parked at the destination, but when no energy sources are close by. Some manufacturers may not fully track use of fuel or battery power degradation in the non-motive mode (i.e., engine off or engine on-mobilizer armed).

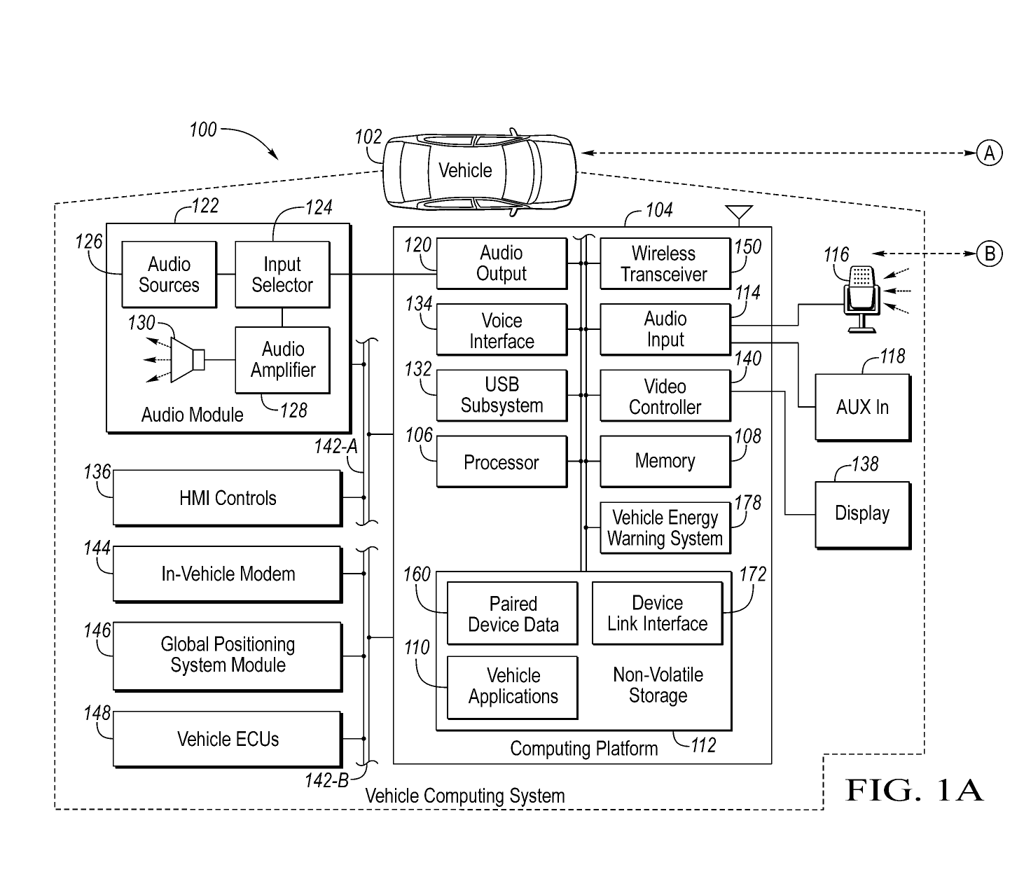

FIGS. 1A and 1B illustrate an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 (including processing capabilities) configured to receive spoken commands from vehicle occupants through a connected microphone 116, and/or auxiliary audio input 118 configured to receive audio signals from connected devices. The auxiliary audio input 118 may be a physical connection, such as an electrical wire or a fiber optic cable, or a wireless input, such as a BLUETOOTH or Wi-Fi audio connection. In some examples, the audio input 114 may be configured to provide audio processing capabilities, such as pre-amplification of low-level signals, and conversion of analog inputs into digital data, or digital signal processing to prepare information for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated) or audio cables or via BLUETOOTH or WI-FI audio streaming to paired compatible portable listening devices (ex., MP3 player, smartphone or other smart device). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities, while in other cases the display might be a nomadic remote control device, such as a phone or tablet used by the MYFORDMOBILE feature. MYFORDMOBILE allows remote control of navigation and other telematics based features.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a near field communication (NFC) transceiver, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communication over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif. The vehicle component interface application 174 may be once such application installed to the mobile device 152.

The vehicle component interface application 174 of the mobile device 152 may be configured to facilitate access to one or more vehicle 102 features made available for device configuration by the vehicle 102. In some cases, the available vehicle 102 features may be accessible by a single vehicle component interface application 174, in which case such the vehicle component interface application 174 may be configured to be customizable or to maintain configurations supportive of the specific vehicle 102 brand/model and option packages. In an example, the vehicle component interface application 174 may be configured to receive, from the vehicle 102, a definition of the features that are available to be controlled, display a user interface descriptive of the available features, and provide user input from the user interface to the vehicle 102 to allow the user to control the indicated features. As exampled in detail below, an appropriate mobile device 152 to display the vehicle component interface application 174 may be identified, and a definition of the user interface to display may be provided to the identified vehicle component interface application 174 for display to the user.

Systems such as the system 100 and system 200 may require mobile device 152 pairing with the computing platform 104 and/or other setup operations. However, as explained in detail below, a system may be configured to allow vehicle occupants to seamlessly interact with user interface elements in their vehicle or with any other framework-enabled vehicle, without requiring the mobile device 152 or wearable device 202 to have been paired with or be in communication with the computing platform 104.

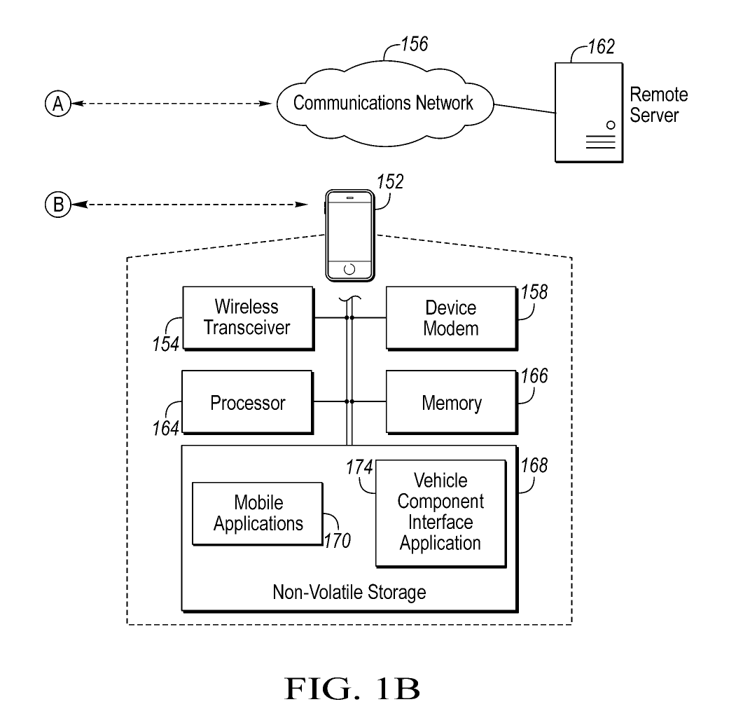

FIGS. 2A and 2B illustrate example vehicle routes 200 including a starting point 215 (shown at point A) and an endpoint, waypoint, or destination 225 (shown at point B). The route 200 may include a first route 205 extending from the start point 215 to the destination 225. The first route 205 may include a first energy source 220, such as a charge station or fuel station. And a second route 210 may extend from the destination 225 two a second energy source 230. The first and second energy sources 220, 230 may include one or both of charging stations for electrical vehicle and traditional fuel stations. The energy sources 220, 230 may be home charging stations, commercial gas stations, electric vehicle charge stations or standalone adapters located in a parking structure. The endpoint, waypoint, or destination 225 may be the desired destination as inputted into the vehicle energy alert system 178 via the HMI 136. The destination 225 may be any number of desired endpoints such as residences or businesses, a point of interest such as shopping center, mall etc., as well as any other type of destination including airports, campgrounds, etc. The destination 225 may be a waypoint, or a stopping point along a route and waypoint and destination 225 are used interchangeably herein. Some destinations 225 may include an energy supply such as this charge station or fuel station. Thus, at these destinations, the vehicle may be refueled and/or recharged. Some destinations 225 may not have an energy supply nearby, as indicated by FIGS. 2A and 2B.

The vehicle energy alert system 178 may be configured to generate the route 200 upon receiving the destination location at the HMI 136. That is, once the driver inputs an address into the HMI 136, the vehicle energy alert system 178 in conjunction with the global positioning module 146, may generate the first route 205 to the destination 225. The vehicle energy alert system 178 may also generate a predicted trip time and predicted trip distance in mileage based on the first route. Upon predicting a trip time and mileage, the vehicle energy alert system 178 may determine whether the vehicle has enough energy (e.g., fuel and/or battery power) to make it to the destination 225 and subsequently make it to the next closest energy source (e.g., the second energy source 230). That is, the vehicle energy alert system 178 may determine if the predicted energy required for the route 200 exceeds the current vehicle energy (also referred to as the energy level). In response to such a determination, vehicle energy alert system 178 may alert the driver as to the energy deficiencies via the HMI 136 and/or the user device 152. The vehicle energy alert system 178 may also provide information as to potential energy sources (e.g., fuel stations and/or charge stations), alternate routes to reach these energy sources, and amount of time remaining until vehicle energy is depleted based on customer usage patterns up to the time of the alert. The system may also suggest ways to avoid further energy consumption based on usage sources measured up to the alert. For example, The system 178 may advise against radio use, frequent door openings, remote starts, allowing elevated cabin temperatures, or the system 178 may instruct the vehicle modem to shut down, among other unnecessary consumption sources (e.g., passive-entry passive-start (PEPS) system components such as the handles on all four doors while maintaining keypad push) until the next key cycle, etc.

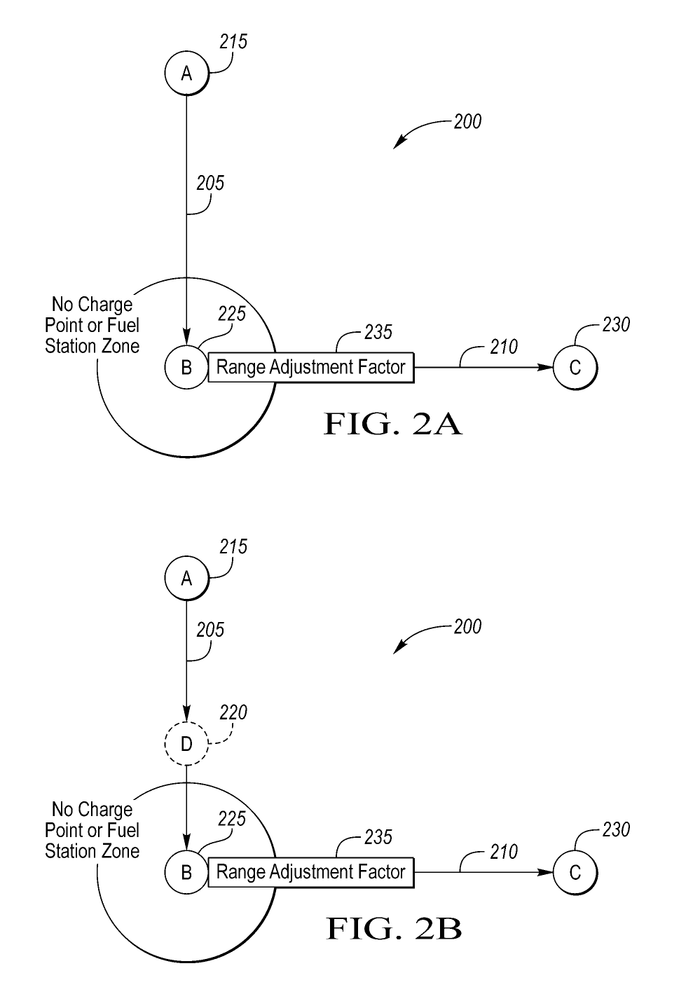

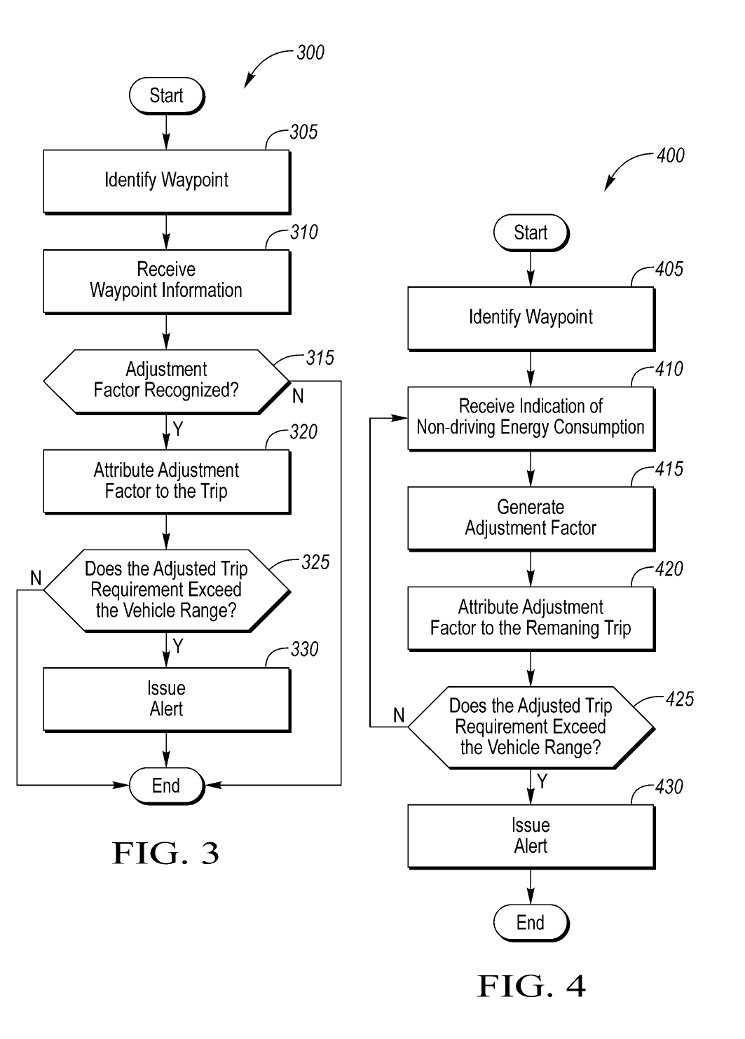

In addition to determining the predicted energy required for the route 200, the vehicle energy alert system 178 may also classify the destination 225 and determine whether the predicted energy requirement should be adjusted based on the destination classification. That is, the vehicle energy may be affected by non-driving energy consumption at the destination. This may be the case when a vehicle is parked at a certain destination 225 for a long period of time, such as the airport. This may also be the case when a vehicle is parked at a certain destination 225 and continually accessed while it is parked at the destination 225, such as a campground or tailgate location. In these examples additional energy may be consumed by routinely opening and closing vehicle doors, utilizing vehicle features such as light, audio systems, lift gate, etc. Thus, the vehicle energy alert system 178 may consider the energy consumed at the destination 225 when determining the energy required to make it from the start point 215 to the destination 225 and then to the energy source 230. Upon determining that non-driving energy consumption may occur at the destination 225, vehicle energy alert system 178 may adjust the predicted energy use to include a range adjustment factor 235 attributable to the non-driving energy consumption. That is, the non-driving energy consumption may be added to the predicted driving consumption to achieve a better, or modified, range estimate for the vehicle energy level. This process is described in more detail with respect to FIGS. 3 and 4 below.

As shown by the example in FIG. 2B, the first route 205 may include an energy source 230. Upon determining that the adjusted energy requirement exceeds the current vehicle energy, the vehicle energy alert system 178 may issue an alert to the driver that a pre-charge may be necessary. That is, the vehicle should be refueled or recharged prior to reaching the destination 225. The alert may be issued via audio, video, and/or tactile mechanisms. In one example, an alert may be displayed via the vehicle HMI. In another example, the alert may be displayed via the mobile device 152. Other forms of alerts may be audible alerts via the audio output 120 or other speakers on the mobile device 152. This audible alert may also be customized to warn about reducing the sources of power consumption observed by the system 178.

In determining the adjustment factor 235, the vehicle energy alert system 178 may take into consideration a number of adjustment elements (also referred to as destination attributes). These adjustment elements may include, but are not limited to the amount of time a vehicle will be at the destination 225 or waypoint 225, the ambient temperature or average ambient temperature at the vehicle for the duration of its stay at the waypoint 225, past power consumption at the destination 225 or a similar destination, typical activity at the destination 225 or a similar destination, proximity to the nearest charge station, among others. The vehicle energy alert system 178, or other vehicle systems, may log past energy consumption at the destination 225 in the non-volatile memory 112, the remote server 162, or other database. The vehicle energy alert system 178 may be configured to classify various destinations 225 and waypoints. The classification may be made based on location data associated with the destinations such as the type of establishment, typical events held here, etc.

This location data/information may be received form an external data source such as an external map system, such as Bing, Google Maps, etc. Data may also be received from the mobile device 152. This data may be received from a calendar, email application, etc., and may be used to classify a destination 225. In one example, if a calendar entry includes an address and a description of an event, such as “Tailgate for Lions game,” then the vehicle energy alert system 178, upon receiving this information, may associate the description with the current destination 225. Thus, the vehicle energy alert system 178 may classify this location as a stadium, or as a tailgate location. Certain destinations 225 may be classified for global purposes and others may be classified on a per event bases. That is, a campground may always be a campground with expected non-driving energy consumption. However, a stadium may be classified as such, and also as tailgate location, depending on the planned activity of the user.

The adjustment elements/attributes may also include a length of stay. The length of stay may be configured and transmitted to the vehicle energy alert system 178 by user input, user data such as calendar entries, among others. The length of stay may indicate how long the vehicle is to remain, or be parked, at the destination 225. The length of stay may be used to determine the adjustment factor 235. In one example, if a certain amount of power is consumed each day during camping, then the adjustment factor 235 may include the average power consumed times the amount of days the user plans to camp.

The adjustment elements may also include an average ambient temperature at the destination 225 during the vehicle's stay at the destination 225, or it may include, or adjust predictions, based on actual measurements made by the vehicle once parked. The temperature may affect a battery's state of charge, and extremely cool temperatures may decrease the battery's state of charge. This may be important in the example where the vehicle is parked at an airport for an extended period of time.

One or more of the adjustment elements may be used to determine the adjustment factor 235. For example, both temperature and length of stay may be considered when determining the adjustment factor 235 at an airport.

FIG. 3 illustrates an example process 300 for the vehicle energy alert system 178, specifically for predicting when the user of an adjustment factor 235 is appropriate in determining an energy alert.

The process 300 begins at block 305 where the vehicle energy alert system 178 identifies a waypoint 225 or destination 225. The waypoint 225, as explained, may be an address inputted by the user at the HMI 136. The waypoint 225 may also be a point of interest, a saved location in longitude, latitude, and altitude, etc.

At block 310, the vehicle energy alert system 178 may receive information 225 associated with the waypoint 225. This information may include adjustment elements such as the amount of time a vehicle will be at the destination 225 or waypoint 225, the ambient temperature or average ambient temperature at the vehicle for the duration of its stay at the waypoint 225, past power consumption at the destination 225 or a similar destination, typical activity at the destination 225 or a similar destination, among others.

At block 315, the vehicle energy alert system 178 may evaluate the information/adjustment elements and determine whether an adjustment factor 235 is necessary based on the adjustment elements, and if so, what the adjustment factor 235 should be. In one example, where the destination 225 is the driver's home, no adjustment factor 235 may be necessary. However, if the destination 225 is an airport and the information indicates the car will be parked for 7 days, then an adjustment factor 235 may be necessary. If the vehicle energy alert system 178 recognizes an adjustment factor 235, the process 300 proceeds to block 320. If not, the process ends.

At block 320, the adjustment factor 235 is added to the power requirement for the trip. That is, the amount of power expected to be consumed during driving may be added to the amount of power expected to be consumed at the waypoint 225.

At block 325, the vehicle energy alert system 178 may determine whether the adjusted power requirement exceeds the current vehicle energy (including electric and fuel). If so, the process proceeds to block 330. If not the process ends.

At block 330, the vehicle energy alert system 178 may issue an alert. The alert may be issued via audio, video, and/or tactile mechanisms. The alert may include instructions, including but not limited to: 1. recommending a pre-charge prior to arrival at the destination 225; 2. recommending an intermediate charge during the stay at the destination 225; and/or 3. recommending adding an additional power source or power pack. Other information may also be displayed via the alert such as the amount of time until the vehicle energy is depleted. The process may then end.

FIG. 4 illustrates an example process 400 for the vehicle energy alert system 178, specifically for determining that an adjustment factor 235 is appropriate in view of current energy consumption at a destination 225. That is, while the process 300 described above with respect to FIG. 3 may predict if and when non-driving activity is expected to make an impact on the stored energy of a vehicle prior to arrival at the destination 225, process 400 may recognize that current non-driving activity may have a profound effect on the stored energy of the vehicle during a vehicle's stay at the destination 225. Thus, even if an alert is not issued prior to the arrival at the destination 225, the vehicle energy alert system 178 may still monitor non-driving energy consumption.

The process 400 begins at block 405 where the vehicle energy alert system 178 identifies a waypoint 225, similar to block 305 above.

At block 410, the vehicle energy alert system 178 receives an indication of non-driving energy consumption. This indication may be received from the BECM (battery electric control module), or other vehicle ECUs 148. The indication may include an average amount of power being consumed per time unit, such as the average amount of power consumed per hour. As explained, this power may be consumed by using various vehicle systems, such as the audio system, lights, opening and closing the doors, charging external devices via input ports (e.g., USB's, other DC connectors such as a cigarette lighter receptacle, etc.)

At block 415, the vehicle energy alert system 178 may generate an adjustment factor 235 based on the indication. The adjustment factor 235 may be determined based on the average power consumption. Although not shown, additional adjustment elements may also be taken into consideration such as those described above. For example, if the vehicle is using a certain average amount of energy each hour, and information received from a user's calendar indicates that the vehicle is to be parked at the destination 225 for the next three days, then the adjustment factor 235 may be determined based on the average energy and the duration of the stay. Other factors such as temperature may also be used.

At block 420, the determined adjustment factor 235 is added to the power requirement for the trip. That is, the amount of power expected to be consumed in driving to the second energy source 230 is added to the amount of power expected to be consumed for the duration of the vehicle's stay at the destination 225.

At block 425, the vehicle energy alert system 178 may determine whether the adjusted power requirement exceeds the current vehicle energy (including electric and fuel). If so, the process proceeds to block 430. If not, the process returns to block 410 and continues to monitor non-driving energy consumption.

At block 430, the vehicle energy alert system 178 may issue an alert. The alert may be issued via audio, video, and/or tactile mechanisms. The alert may include instructions, including but not limited to: 1. recommending an intermediate charge during the stay at the destination (e.g., leaving the waypoint 225 to charge or refuel during the stay); and/or 2. recommending adding an additional power source or power pack. The process may then end.

Although the processes and systems described herein are described as being accomplished via a vehicle energy alert system, any computer, controller or processor thereof may be used to implement the processes. For example, processor 106 may perform the processes 300 and/or 400 based on information supplied from the alert system 178 and/or other vehicle systems. Additionally or alternatively, the remote service 162 and/or the mobile device 152 may also perform the analysis.

Computing devices, such as the mixer, remote device, external server, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle alert system comprising:
a controller configured to receive waypoint information indicative of non-driving energy consumption associated with a waypoint, to modify an estimate of vehicle energy necessary to travel to the waypoint based on the non-driving energy consumption to generate a modified estimate, and to issue an alert in response to the modified estimate exceeding a current vehicle energy.

2. The system of claim 1, wherein the modified estimate includes energy necessary to drive from the waypoint to a next closest energy station.

3. The system of claim 1, wherein the waypoint information includes one of predicted and measured non-driving vehicle activity associated with the waypoint.

4. The system of claim 1, wherein the waypoint information includes a length of stay at the waypoint.

5. The system of claim 4, wherein the waypoint information includes an expected average ambient temperature at the waypoint during the length of the stay.

6. The system of claim 1, wherein the current vehicle energy includes at least one of fuel energy and battery energy.

7. A vehicle alert method comprising:
by a controller,
receiving a waypoint and a current energy level,
classifying the waypoint based on waypoint attributes indicative of potential non-driving energy consumption at the waypoint,
generating an adjustment factor based on the potential non-driving energy consumption,
modifying the current energy level by the adjustment factor, and
issuing an alert in response to the modified energy level exceeding the current energy level.

8. The method of claim 7, wherein the waypoint attributes include non-driving vehicle activity associated with the waypoint.

9. The method of claim 7, wherein the waypoint attributes include a length of stay at the waypoint.

10. The method of claim 9, wherein the waypoint attributes include an expected average ambient temperature at the waypoint during the length of the stay.

11. The method of claim 7, wherein the current energy level includes at least one of fuel energy and battery energy.

12. The method of claim 9 further comprising determining a distance between the waypoint and a next closest charge station.

13. The method of claim 12, wherein the adjustment factor is further generated based on the distance.

14. A vehicle comprising:
an interface; and
a controller configured to, in response to an indication of expected non-driving energy consumption at a destination for the vehicle, issue an alert via the interface provided an estimate of vehicle energy necessary to travel to the drive cycle destination that is based on the expected non-driving energy consumption exceeds a current vehicle energy.

15. The vehicle of claim 14, wherein the expected non-driving energy consumption includes an amount of energy necessary to leave the destination and reach a charge station.

16. The vehicle of claim 14, wherein the current energy includes at least one of fuel energy and battery energy.

17. The vehicle of claim 14, wherein the expected non-driving energy consumption is an expected average energy consumption at the destination.
